(19) United States
(12) Patent Application Publication
(10) Pub. No.: US 2007/0050310 A1
(43) Pub. Date: Mar. 1, 2007

(54) System and method for enhancing cost performance of mechanical systems

(75) Inventor: Ronald Wingenter, San Antonio, TX (US)

Correspondence Address: TOLER SCHAFFER, LLP, 5000 PLAZA ON THE LAKES, SUITE 265, AUSTIN, TX, 78746, US

(73) Assignee: Standard Aero (San Antonio), Inc., San Antonio, TX (US)

(21) Appl. No.: 11/175,533

(22) Filed: Jul. 6, 2005

Related U.S. Application Data
(60) Provisional application No. 60/643,476, filed on Jan. 13, 2005.

(51) Int. Cl. G06F 17/00

(52) U.S. Cl. 705/400

(57) ABSTRACT

This disclosure is directed to a method to enhance cost performance of a mechanical system. The method includes inspecting the mechanical system to determine a primary work scope. The primary work scope is associated with a first subset of the set of modules. The method further includes accessing a computational system configured to determine an enhanced work scope associated with the first subset and a second subset of modules. The enhanced work scope is determined based on expected cost per unit operation time of the mechanical system. The method also includes performing tasks associated with the enhanced work scope on the mechanical system.

### CROSS-REFERENCE TO RELATED APPLICATION(S)

The present application claims priority from U.S. Provisional Patent Application No. 60/643,476, filed Jan. 13, 2005, entitled “SYSTEM AND METHOD FOR ENHANCING COST PERFORMANCE OF MECHANICAL SYSTEMS,” naming inventor Ronald Wingenter, which application is incorporated by reference herein in its entirety.

### TECHNICAL FIELD OF THE DISCLOSURE

This disclosure, in general, relates to systems and methods for enhancing cost performance of mechanical systems.

### BACKGROUND

Modern mechanical systems include many complex modules that are difficult to maintain and repair. This complexity is applicable for airplane engines, and especially for jet engines, such as those on modern military aircraft. For the airline industry and militaries, costs associated with maintenance and repair of a fleet of aircraft is high. However, failure to maintain an aircraft leads to crashes that cost lives, results in the loss of expensive aircraft, and leads to bad publicity.

As such, the airline industry and militaries frequently inspect aircraft systems including the aircraft's engines. Repair and maintenance of an engine is expensive and, thus, airlines and militaries have attempted to estimate repair costs associated with an engine. When performing an inspection of an aircraft engine, an inspector may notice a module in disrepair and order the engine to be removed from the aircraft and sent for repair. However, once an engine has been removed from the aircraft, additional problems may be discovered and costs typically increase. Previous attempts to estimate repair costs have failed to accurately predict costs. Moreover, typical methods lead to high overall cost performance. As such, an improved system and method for enhancing cost performance would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary computational system.

FIGS. 2, 3, and 4 include illustrations of exemplary methods for enhancing cost performance using a computational system, such as the exemplary computational system of FIG. 1.

FIGS. 5 and 6 include illustrations of exemplary user interfaces provided by a computational system, such as the exemplary computational system of FIG. 1.

FIGS. 7 and 8 include illustrations of exemplary methods for determining cost.

FIGS. 9, 10, 11, 12, 13, 14, 15, 16, 17, 18 and 19 include illustrations of exemplary user interfaces provided by a computational system, such as the exemplary computational system of FIG. 1.

The use of the same reference symbols in different drawings indicates similar or identical items.

### DESCRIPTION OF THE DRAWING(S)

In one particular embodiment, the disclosure is directed to a method for enhancing cost performance of a mechanical system, such as an aircraft engine. The mechanical system may be inspected and a primary work scope determined. The primary work scope generally includes a set of tasks associated with maintenance of the mechanical system or a set of modules designated for overhaul, repair or replacement. The primary work scope is entered into a computational system and the system determines an enhanced work scope configured to enhance a cost performance parameter, such as cost per unit operation time. Operation time includes the amount of time the mechanical system and/or modules of the mechanical system are in operation (e.g. flying hours for an aircraft engine). The enhanced work scope generally includes the set of tasks of the primary work scope and an additional set of tasks that are expected to improve cost performance. The enhanced work scope is provided to maintenance personnel and the tasks are performed. Further data determined after the tasks are completed, such as the actual cost of the maintenance or the actual operation time of the mechanical system between repairs may be entered into the system to further enhance models used in determining the enhanced work scope.

In another exemplary embodiment, a method for enhancing cost performance includes determining expected operation times (i.e. time between failure or maintenance of the mechanical system) and determining expected cost per unit operation time for selected work scopes of a set of possible work scopes. An enhanced work scope is selected from the set of possible work scopes based on performance criteria, such as selecting a work scope having a low cost performance parameter and at least a particular operation time.

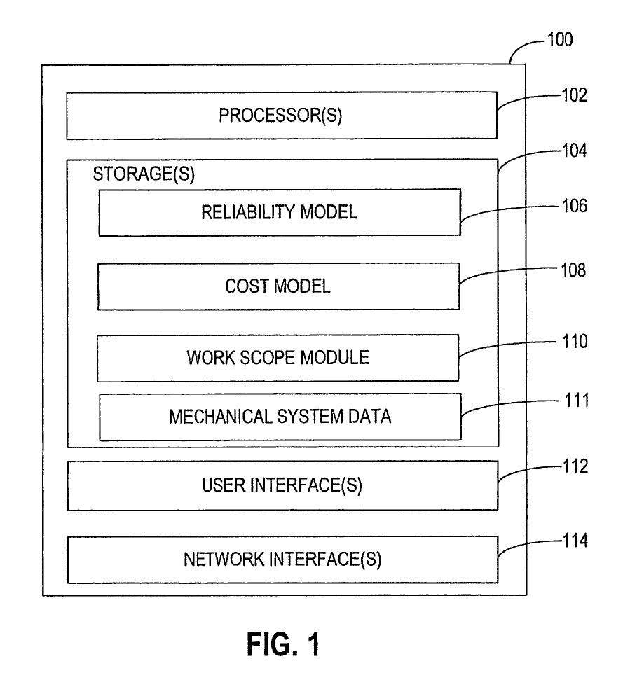

The methods may be implemented in a computational system, such as a laptop or desktop computer, depending on portability and speed preferences. FIG. 1 illustrates an exemplary computer system 100, which includes one or more processors 102, one or more memory devices 104, user interface devices 112, and, optionally, a network interface device 114. The one or more memory devices 104, the user interface devices 112, and optional network interface devices 114 are accessible to the one or more processors 102.

The user interface devices 112 are operable by the processors 102 to provide interactive interfaces for human interaction. For example, the user interface devices 112 may include a keyboard, a mouse, a monitor.

The network interface devices 114 may be operable by the processor 102 to access remote computer systems via communications networks, such as wireless and wired communications networks. Such communications networks include Ethernet networks and networks conforming to Wi-Fi, Bluetooth®, and Wi-Max standards. In one exemplary embodiment, the network interface devices 114 may be used to acquire additional data or model parameters associated with a specific mechanical system, or to communicate results to remote systems.

The memory devices 104 may be accessible to the processor 102 and provide software instructions and data to the processor 102 for implementing the above methods. Such memory devices 104 include hard drives, floppy drives, CD-ROM, CD-R, CD-RW, DVD, RAM, and flash memory. The memory devices 104 are configured to store software and computer-implemented instructions, such as a reliability model 106, a cost model 108, a work scope module 110, and mechanical system data 111.

For example, a user may enter the mechanical system data 111 for storage in the memory devices 104. The work scope module 110 includes instructions operable by the processor 102 to determine a set of work scopes and, iterating through the set of work scopes, to determine an enhanced work scope based on the mechanical system data 111. In one example, the work scope module 110 when implemented by the processor 102 accesses the reliability model 106 to determine an expected operation time for a particular work scope and accesses the cost model 108 to determine an expected cost per unit operation time. The work scope module 110 may designate as the enhanced work scope a work scope having at least a particular operation time and a lowest cost per unit operation time.

Alternatively, the computational system 100 may be implemented such that one or more components reside in separate devices. The components, models, modules, and databases may be directly accessible or remotely accessible via one or more networks. In addition, the modules, models, and data may be stored on the same medium or separate media.

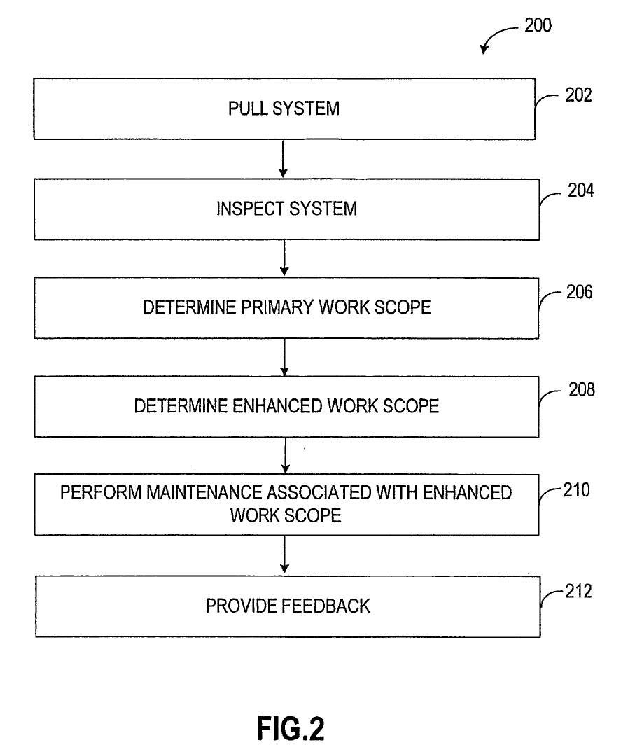

In one exemplary embodiment, the computational system 100 may be used to enhance cost performance with respect to aircraft engine repair. FIG. 2 illustrates an exemplary method 200 for enhancing cost performance. An initial inspection of the aircraft engine results in an order to remove the engine from the aircraft, as illustrated at 202. Typically, an engine is removed from the aircraft when a condition is noted that involves repairs that cannot be accomplished with the engine installed or when, in order to meet operational requirements, an engine repair while the engine is installed would be too time consuming. For the purposes of this discussion the conditions or failures that result in removal of the engine from the wing are herein called “primary failure”. The engine is given an additional inspection, as illustrated at 204, resulting in a primary work scope, as illustrated at 206. The primary work scope generally includes a set of tasks or a list of engine modules to be repaired or overhauled. When an engine is sent to an intermediate shop, it receives a complete inspection using manuals appropriate for the repair level. While the inspection of an engine on-wing is usually terminated once a condition is found that involves engine removal, the inspection in the shop includes the entire engine. It is not uncommon for other conditions to be found that would also have resulted in engine removal when the complete inspection is accomplished. The failures that are actually found sometimes depend on the sequence of inspection. For this reason there may be more than one “primary failure”.

Engine data and the primary work scope are entered into a computational system to determine an enhanced work scope, as illustrated at 208. Generally, the computational system selects a work scope from a set of possible work scopes based, at least in part, on performance criteria. The set of possible work scopes is based on the primary work scope and, typically, the enhanced work scope includes the tasks associated with the primary work scope and additional tasks. However, in some cases, the primary work scope becomes the enhanced work scope after a determination is made as to whether the primary work scope meets the performance criteria.

Based on the enhanced work scope, maintenance is performed on the engine, as illustrated at 210. For example, the engine modules designated in the enhanced work scope may be overhauled, repaired, or replaced. The actual cost of the maintenance and the resulting maintenance free operation time of the engine may be entered into the computational system as feedback, as illustrated at 212. The computational system may adjust the reliability models and cost models based on the feedback data.

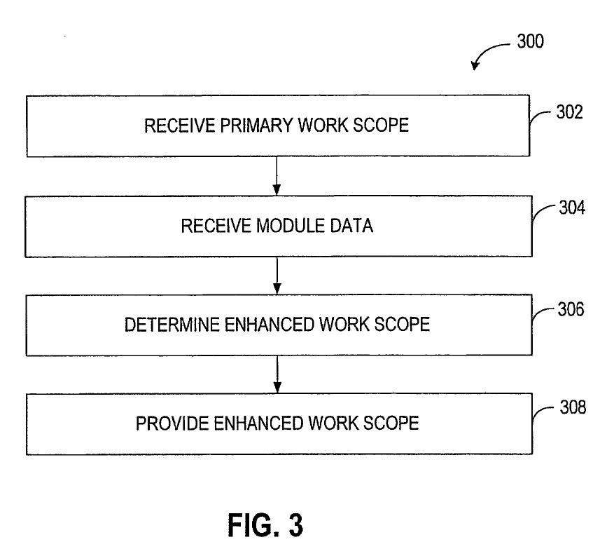

One exemplary method 300 for enhancing cost performance of a mechanical system, such as an aircraft engine, is illustrated in FIG. 3. The computational system receives the primary work scope, as illustrated at 302, and receives module data, as illustrated at 304. The primary work scope may include a first list of modules to be overhauled, replaced, or repaired. The module data includes data on the individual modules of the aircraft engine, such as time in operation and state of repair.

An enhanced work scope is determined, as illustrated at 306. The enhanced work scope may include the first list of modules and a second list including one or more additional modules to be overhauled, replaced or repaired. The enhanced work scope is provided to maintenance personnel, as illustrated at 308.

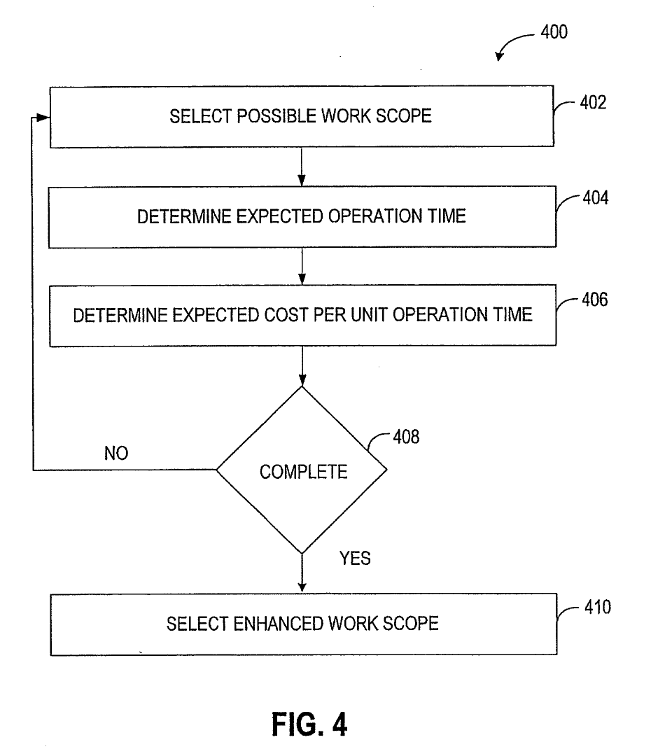

The enhanced work scope may be determined through exemplary method 400 illustrated in FIG. 4. A work scope is selected from a set of possible work scopes, as illustrated at 402. The set of possible work scopes are generally those work scopes that include at least the primary work scope. For example, if an engine has thirteen modules and three are included in the primary work scope, the possible work scopes are those work scopes that include at least the three modules included in the primary work scope. Possible work scopes may include 3, 4, 5 and up to 13 modules. The total number of possible work scopes may be, for example 2¹³/2³ or 1024. Additional logic may be used to reduce the number of work scopes, such as artificial intelligence methods.

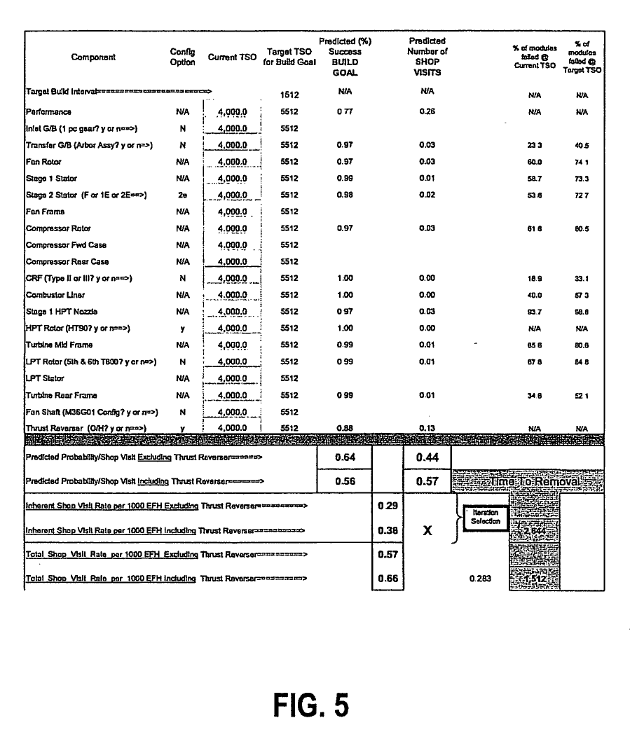

Once a work scope is selected from the possible work scopes, the computational system determines an expected failure free operation time. For example, the computational system may use a reliability model or predictor tool. In one particular embodiment, the predictor tool is implemented as an Microsoft Excel® spreadsheet that computes engine time on wing (ETOW) for the engine to be repaired. FIG. 5 includes an exemplary screen shot of the predictor tool main page. Operation times associated with the engine modules are entered into the predictor tool. Times for the modules that are included in the primary work scope or for which a decision is made to overhaul may be entered as zeros. The ETOW is computed with the assistance of, for example, an iterative Visual Basic for Applications (VBA) routine using the failure distributions (e.g., Weibulls curves) for each of the modules plus factors accounting for other failures.

Returning to FIG. 4, an expected cost performance is determined for the selected work scope, as illustrated at 406. The computational system may access a cost model to determine expected costs and divide these expected costs by the ETOW. In one particular embodiment, the cost model models costs associated with unexpected repairs (termed “sunshine costs”), engine module use costs, premature removal risk, and engine module residual value. The cost model may also include costs associated with availability/non-availability of the aircraft, transportation costs for the failed and replaced engine and engine modules, cost of maintaining spares, cost of actual removal and replacement of the engine on the aircraft, engine test cost, and potential cost of functional test flights.

When the engine is disassembled for repair, other conditions are often found that require repair in accordance with manuals used in the repair shop. These conditions are not visible while the engine is assembled. Therefore, the actual work-scope performed on an engine in the intermediate shop and the cost are typically considerably larger than the planned work scope (i.e., the primary work scope or the enhanced work scope). The cost of repair of these “hidden” conditions is often referred to as “sunshine” cost because the defects are not visible until the engine is disassembled. The sunshine costs vary depending on the specific primary failure(s) and the level of disassembly required to repair the failure. The sunshine cost is often a large percentage of the total cost of repair for a particular engine removal.

On an exemplary engine, stage 1 and stage 2 fan stators and the fan rotor are removed from the front of the engine and everything else is disassembled from the rear. The last two components that may be separated are the compressor and the fan frame. Removal of the fan shaft or inlet gearbox requires major disassembly but primary failures are not common on these items. As a result, a greater degree of disassembly is associated with greater sunshine cost.

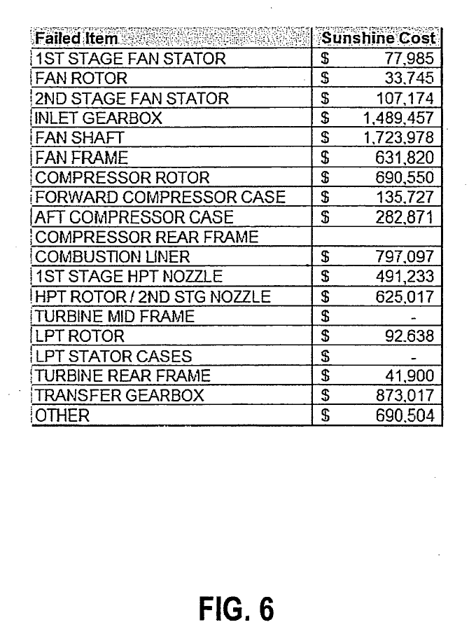

In one exemplary model, data of a set of engines from a maintenance and repair database is used to calculate the sunshine costs. For each engine, conditions found during maintenance that required module overhaul and that are not considered primary failures (e.g., failures that result in removal of the engine from the wing) were associated with the primary failures using a set of rules derived from the order in which the engine is disassembled given the primary failure. FIG. 6 illustrates exemplary sunshine cost values. The sunshine cost values represent the expected sunshine component of cost associated with each primary failure.

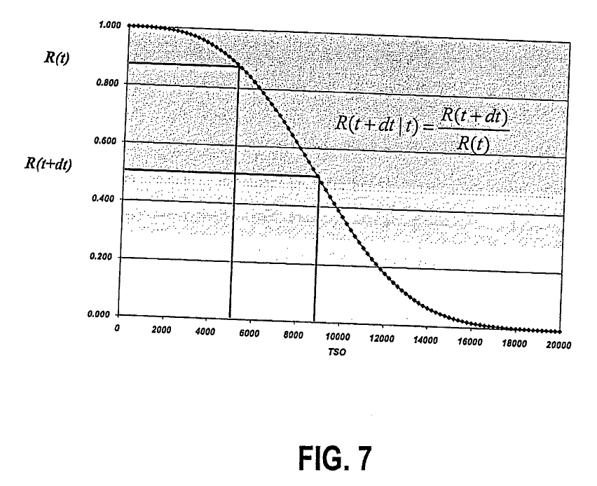

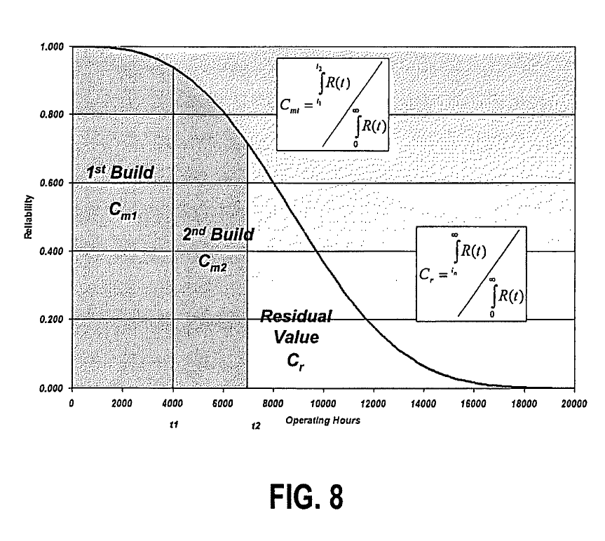

Most of the individual engine modules and components typically last much longer than the average operating time between engine removals. A value is associated with the individual engine module at the time of engine build and a residual value at the end of the ETOW. The difference is the cost of the engine module for the current build. The cost of overhaul of a specific engine module may be treated as a capital investment to be amortized over the life of the engine module. The cost model may use the reliability of the engine module at the current time based on its individual failure distribution to compute its value at the time the engine is being maintained. The initial value is the overhaul cost times the reliability (equal to 1 for a newly overhauled engine module). The reliability of the engine module at the end of the ETOW is used to compute the residual value. The difference between the initial value and the residual value is assessed against the current build as a “module use” cost. FIG. 7 further illustrates this point.

Another cost element that may be included in the cost model is a cost associated with the risk of premature removal of the engine module. This cost can be computed for each engine module individually depending on its failure distribution and the operation time of the individual engine module. This cost is included as risk in the cost model.

A fourth cost is a cost associated with the residual value of an engine module when it is determined that the engine module should be overhauled to improve cost performance, such as cost per engine flying hour. The residual value of a failed engine module is zero but, when a decision is made to overhaul an engine module when it has significant life left, it has value that is not used and therefore represents a cost.

Other costs that may be included in the model are: costs associated with availability/non availability of the aircraft; transportation costs for the failed and replacement engines; cost of maintaining spares; cost of actual removal and replacement of the engine on the aircraft; engine test cost; and potential cost of functional check flights.

In one exemplary embodiment, the cost performance is a cost per unit operation time, such as cost per engine flying hours. In one particular embodiment, the cost model includes four cost components: engine module use cost, sunshine cost, risk cost, and residual value of operational engine modules for which a decision was made to overhaul. The cost per engine flying hour is computed by dividing the sum of the cost components by the expected failure free operation time.

Returning to FIG. 4, the cost is computed for each of the possible decisions regarding overhaul or non-overhaul of each of the modules and components. Once the costs are determined, as illustrated at 408, the system selects an enhanced work scope, as illustrated at 410. If there are no primary failures among the thirteen, a total of 2¹³ or 8192 combinations exist. For an engine module that is a primary failure, the decision to overhaul that particular module is assumed and the number of required computations is decreased by a factor of 2. The results may be presented graphically and a table is generated showing the enhanced work scope within the constraint of a minimum ETOW. For the example, the minimum ETOW may be set at 2000 hours, but can be set to whatever value is desired. Typically, the maximum achievable ETOW for an exemplary engine is above the minimum ETOW, such as above 2449 hours.

### EXAMPLE I

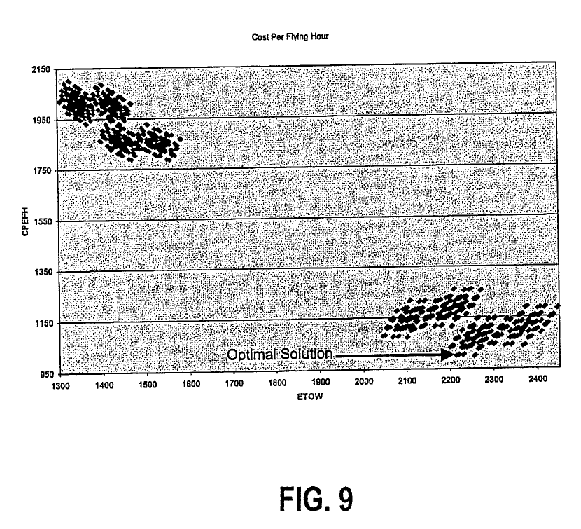

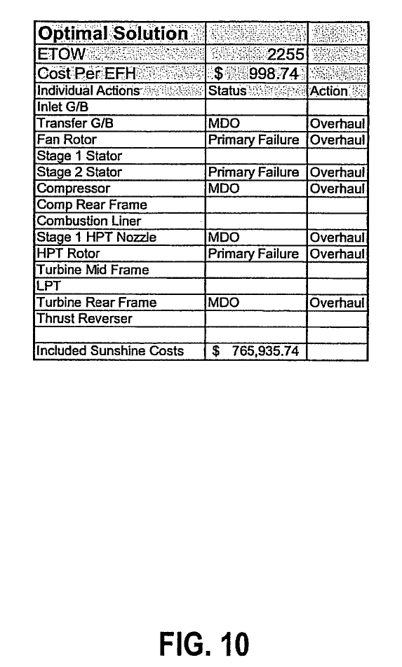

The first example presented is a relatively high time engine that is removed after 2161 hours on wing. A primary failure is assumed in the fan rotor and second stage stator. Upon further inspection another primary failure is found in the HPT. These three modules are designated for overhaul because of the primary failures. The cost model results are illustrated in the chart illustrated in FIG. 9 and in the table illustrated in FIG. 10.

Each point on the chart represents a specific work scope decision. In this case there are a total of 1024 possible decisions—2¹³/2³—because of the three failures. The two major clusters shown on the chart are typical for high time engines. The cluster on the left represents those options that do not call for overhaul of the compressor and the major cluster on the right represents those options that do. The two minor clusters on the lower right represent the options that do and do not call for overhaul of the HPT rotor. The table illustrated in FIG. 10 reflects the enhanced work scope.

In addition to the primary failed modules, the transfer gearbox, compressor, 1st stage HPT nozzle and turbine rear frame are to be overhauled. For the purpose of this model the compressor rotor and the two compressor cases are treated as a unit. A Management Directed Overhaul (MDO) for the compressor includes the cost of overhauling the forward and aft cases as well as the rotor. A total of $765,935 for sunshine costs that may be discovered when the engine is disassembled is included in the cost of the enhanced work scope, as is a total of $224,204 to compensate for the residual value of the transfer G/B, compressor, 1st stage nozzle and turbine rear frame. It should be emphasized that the enhanced work scope is the planned work-scope and the final work-scope actually performed on the engine may contain an average of $765,935 dollars (the value of the sunshine costs) in additional overhauls.

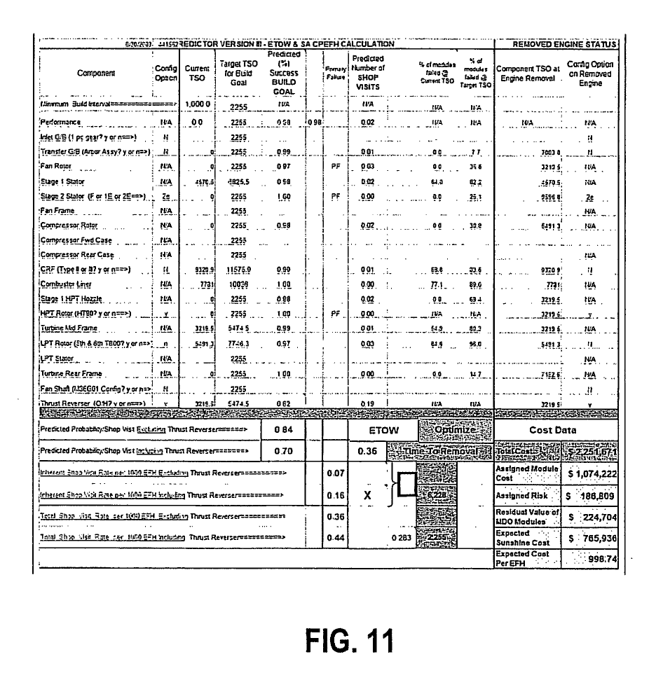

FIG. 11 includes an illustration of the costs for the enhance work scope. Generally, the total cost illustrated in FIG. 11 is not to be interpreted as a shop visit cost. It represents the cost assigned to this particular work scope and includes the “module use” cost for each module used in the build. It also includes an “assigned risk” element that represents the expected value of pre-mature shop visits based on the reliability of the modules involved.

### EXAMPLE II

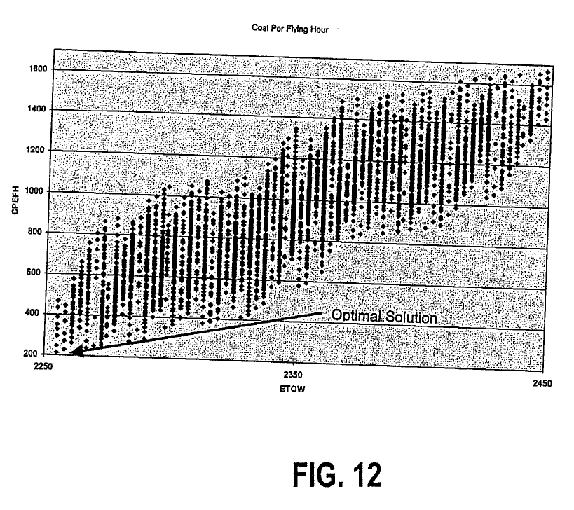

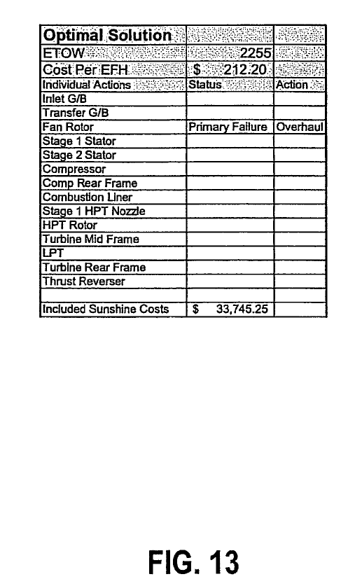

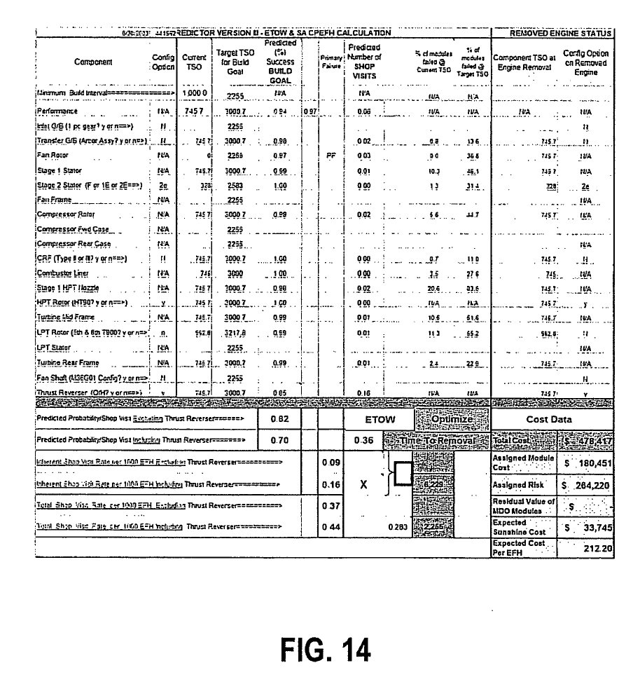

This example represents a low time engine that is removed for fan rotor damage. The fan rotor is the primary failure. The chart is illustrated in FIG. 12, the table is illustrated in FIG. 13 and the costs are illustrated in FIG. 14.

This example demonstrates that the cost model recommends minimal repair if the modules have low operation time. The value of the sunshine costs is low because removal of the fan rotor requires disassembly of the forward portion of the engine. The chart contains a total of 4096 points because of the single primary failure.

### EXAMPLE III

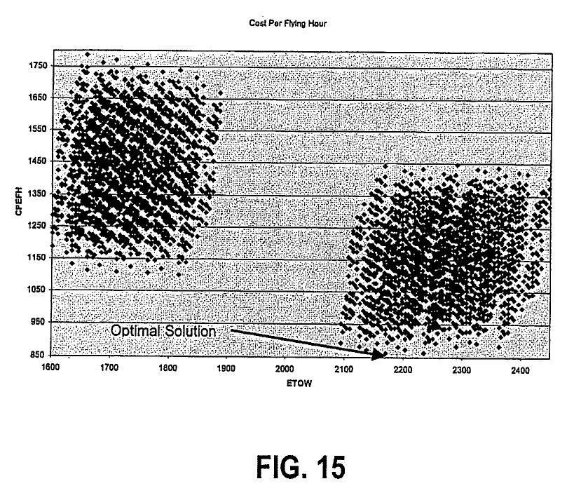

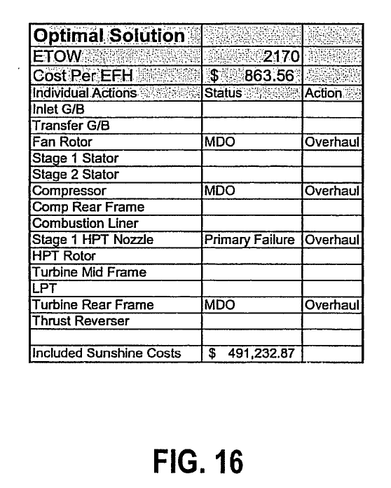

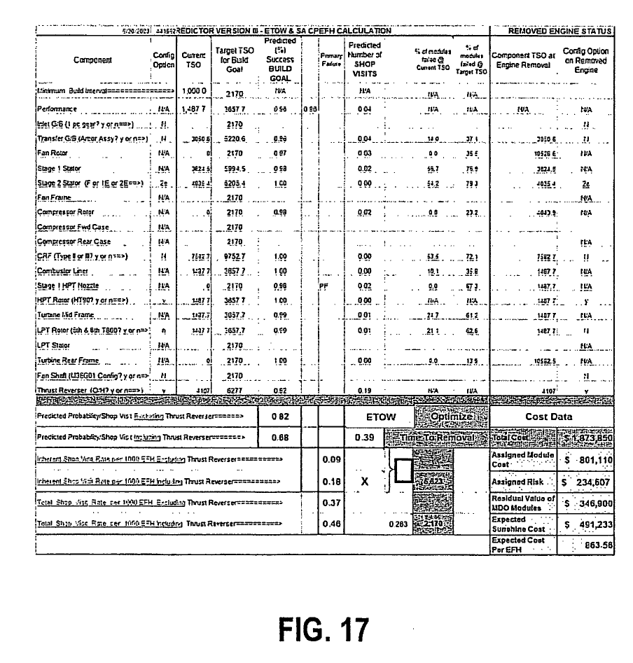

A third example is presented which represents an engine with mid-range times on the modules. This engine is depicted as having been removed for a problem with the first stage nozzle. The cost per flying hour chart is illustrated in FIG. 15, the table including the enhanced work scope is illustrated in FIG. 16, and the costs are illustrated in FIG. 17. The incoming times on the modules are mixed, as illustrated in FIG. 17.

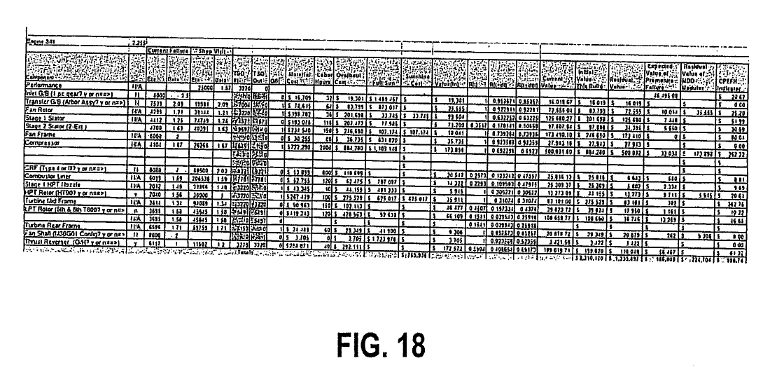

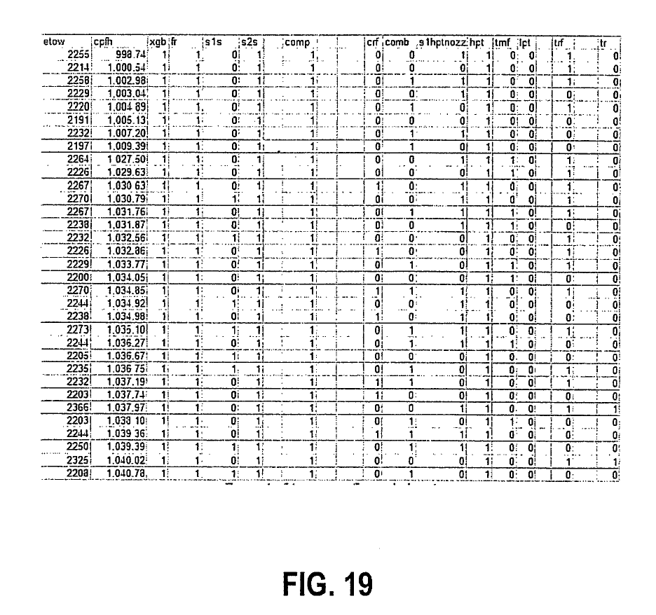

As illustrated in FIGS. 18 and 19, embodiments of the above methods may be implemented using a spreadsheet. In a particular embodiment, the model is implemented by:

1. Entering the incoming operation times of the various modules and components in the predictor tool worksheet;

2. Identifying the items that are primary failures;

3. Identifying those items that will be forced to overhaul (typically the same as the primary failures);

4. Clicking an ETOW button to display the expected result of the specified or primary work scope—that is, the results of only overhauling those items that were identified for overhaul, such as ETOW and costs;

5. Clicking an Optimize button to determine the enhanced work scope (The system iterates through the combinations and produces the chart and enhanced work scope table. In one implementation, the model may take several minutes to run depending on the speed of the computer and the number of items forced to overhaul. In one example, the cost vs tow sheet is updated as each set of 100 computations are completed). Costs may be determined using a cost model, such as the cost model spreadsheet illustrated in FIG. 18; and

6. Reading the enhanced work scope. The Enhanced work scope may be presented in a table. The possible work scopes may be presented on a chart. In one embodiment, if details of another solution are desired, the point can be highlighted on the chart, the cost and ETOW noted and the work scope is then illustrated on a worksheet titled “tow vs cpeh”. This worksheet contains the possible solutions and is sorted by cost per engine flying hour (CPEFH). A “1” in the column for a specific module means that that the module was overhauled for that particular data point, as illustrated in FIG. 19.

Particular embodiments of the systems and methods yield work scopes that are consistent with the intuitive notion that there is a point at which it is more economical to overhaul an engine module than re-use it. Rather than set soft or hard times for the individual engine modules, the system considers the engine as a whole and recommends actions based on cost. The enhanced work scope generally represents the initial work-scope plan and the minimum work to be accomplished on the engine. The final tasks performed on a particular engine often include a wider work scope than the primary or enhanced work scopes. The costs associated with broadening of the work scope are included in the cost model as “sunshine cost,” but that work is not specifically defined when the work scope plan is initiated. Costs associated with the actual work scope and failure free operation times of the engine after the actual work scope is performed may be fed back to the models to enhance future estimations.

For additional examples of user interfaces see FIGS. 17 and 18.

The above-disclosed subject matter is to be considered illustrative, and not restrictive, and the appended claims are intended to cover all such modifications, enhancements, and other embodiments, which fall within the true scope of the present invention.

1. A method for enhancing cost performance of a mechanical system, the method comprising:
receiving a primary work scope, the primary work scope comprising a set of tasks associated with maintenance of the mechanical system;
determining an enhanced work scope, the enhanced work scope including the primary work scope and at least one additional task associated with maintenance of the mechanical system, the enhanced work scope configured to enhance a cost performance parameter; and
providing the enhanced work scope.

2. The method of claim 1, wherein the mechanical system includes a set of modules, the method further comprising receiving module data associated with individual modules of the set of modules.

3. The method of claim 1, wherein the cost performance parameter is cost per unit operation time.

4-6. (canceled)

7. The method of claim 1, wherein determining the enhanced work scope comprises determining an estimated maintenance free operation time based on the enhanced work scope.

8. The method of claim 7, wherein determining the enhanced work scope further comprises determining an estimated cost based on the enhanced work scope.

9. The method of claim 8, wherein determining the estimated operation time and determining the estimated costs are performed iteratively for possible work scopes and wherein one of the possible work scopes is selected as the enhanced work scope based on performance criteria.

10. A method for enhancing cost performance of a mechanical system, the method comprising:
receiving a primary work scope associated with maintenance of the mechanical system; and
determining an enhanced work scope by iteratively:
determining a secondary work scope associated with maintenance of the mechanical system and based on the primary work scope;
determining an expected operation time of the mechanical system based on the secondary work scope; and
determining an expected cost per operation time based on the secondary work scope and the expected operation time; and
providing the enhanced work scope.

11. The method of claim 10, wherein the enhanced work scope includes the secondary work scope when the secondary work scope meets cost performance criteria.

12. The method of claim 11, wherein the cost performance criteria includes cost per unit operation time and wherein the performance criteria includes selecting the secondary work scope having the lowest cost per unit operation time.

13. The method of claim 12, wherein the performance criteria includes selecting the secondary work scope when the expected operation time is above a particular operation time.

14. The method of claim 10, wherein the mechanical system includes a set of modules and wherein determining the expected operation time of the mechanical system includes determining the expected operation time based on expected performance of each module of the set of modules.

15. The method of claim 10, wherein the mechanical system includes a set of modules and wherein determining the expected cost per operation time includes determining sunshine costs based on a subset of the set of modules.

16. The method of claim 15, wherein the subset of the set of modules is associated with the primary work scope.

17. The method of claim 10, wherein the mechanical system includes a set of modules and wherein determining the expected cost per operation time includes determining risk cost associated with a module of the set of modules.

18. The method of claim 10, wherein the mechanical system includes a set of modules and wherein determining the expected cost per operation time includes determining module use cost associated with a module of the set of modules.

19. The method of claim 10, wherein the mechanical system includes a set of modules and wherein determining the expected cost per operation time includes determining residual module value associated with a module of the set of modules.

20-21. (canceled)

22. A computational system comprising:
a processor; and
memory accessible to the processor, the memory comprising:
a reliability model;
a cost model; and
a work scope engine operable by the processor to determine an enhanced work scope associated with maintenance of a mechanical system, the enhanced work scope selected from a set of work scopes based on expected performance criteria, the work scope engine configured to access the reliability model to determine an expected operational time based on a selected work scope of the set of work scopes and configured to access the cost model to determine a cost per unit operation based on the selected work scope, the work scope engine configured to determine the expected performance criteria from the expected operational time and the cost per unit operation.

23. The computational system of claim 22, wherein the mechanical system includes a set of modules.

24. The computational system of claim 23, wherein the reliability model includes individual reliability models for each module of the set of modules.

25. The computational system of claim 23, wherein the cost model is configured to estimate sunshine costs.

26. The computational system of claim 25, wherein the memory includes a primary work scope and engine module data and wherein the sunshine costs are a function of the primary work scope.

27-33. (canceled)
